(19) United States
(12) Patent Application Publication
(10) Pub. No.: US 2026/0227732 A1
(43) Pub. Date: Aug. 6, 2026

(54) IMAGE FORMING APPARATUS, IMAGE FORMATION POSITION CONTROL METHOD, AND STORAGE MEDIUM

(71) Applicant: Konica Minolta, Inc., Tokyo (JP)

(72) Inventors: Kouei Cho, Toyohashi-shi (JP); Satoshi Miyajima, Tokyo (JP); Yuta Tachibana, Toyokawa-shi (JP); Kazumichi Yoshida, Tokyo (JP)

(73) Assignee: Konica Minolta, Inc., Tokyo (JP)

(21) Appl. No.: 19/529,672

(22) Filed: Feb. 4, 2026

(30) Foreign Application Priority Data
Feb. 6, 2025 (JP) 2025-018069

(51) Int. Cl. G03G 15/00; G03G 15/01

(52) U.S. Cl. CPC G03G 15/5033; G03G 15/0189; G03G 15/5029; G03G 15/5054

(57) ABSTRACT

An image forming apparatus includes: an image former that forms an image on a sheet via an image carrier; an acquirer that acquires fluctuation information indicating a fluctuation in a drive signal that drives the image carrier; and a hardware processor. The hardware processor controls an image formation position at which the image is formed by the image former, based on the fluctuation information acquired by the acquirer.

### CROSS-REFERENCE TO RELATED APPLICATIONS

The entire disclosure of Japanese Patent Application No. 2025-018069 filed on February 6, 2025, is incorporated herein by reference in its entirety.

### BACKGROUND OF THE INVENTION

### TECHNICAL FIELD

The present disclosure relates to an image forming apparatus, an image formation position control method, and a storage medium.

### DESCRIPTION OF RELATED ART

There is known an electrophotographic image forming apparatus that forms an image on a sheet. An electrophotographic image forming apparatus develops an electrostatic latent image formed on a photoreceptor with toner, transfers the toner image onto a sheet with a transfer section, and fixes the toner image with a fixing section.

According to such an image forming apparatus, an instantaneous fluctuation occurs in the sheet conveyance system when the sheet enters the conveyance rollers or comes out of the conveyance rollers. The conveyance rollers are specifically a secondary transfer roller, a fixing roller, a registration roller, or the like. The sheet conveyance system is specifically an intermediate transfer belt, a photoreceptor, or the like. The instantaneous fluctuation having occurred in the sheet conveyance system causes an instantaneous fluctuation of exposure and transfer in image formation and causes streaky image noise (shock noise).

Japanese Unexamined Patent Application Publication No. 2015-123598 discloses a configuration that detects a stain position by scanning a sheet and outputs image data at a position that does not overlap the detected stain position. According to JP2015-123598A, streaky image noise caused by an instantaneous fluctuation in the sheet conveyance system can be detected, and image data can be output at a position that does not overlap the image noise.

### SUMMARY OF THE INVENTION

The configuration described in JP2015-123598A prints an image on a sheet and scans the sheet to detect the stain position. That is, the configuration of JP2015-123598A needs to perform printing on the sheet and scan the sheet. Such a process of detecting the stain position requires time and cost, and the real-time processing cannot be performed.

An object of the present disclosure is to provide an image forming apparatus, an image formation position control method, and a storage medium capable of sufficiently ensuring image quality while suppressing time and cost.

To achieve at least one of the abovementioned objects, according to an aspect of the present invention, an image forming apparatus includes: an image former that forms an image on a sheet via an image carrier; an acquirer that acquires fluctuation information indicating a fluctuation in a drive signal that drives the image carrier; and a hardware processor that controls an image formation position at which the image is formed by the image former, based on the fluctuation information acquired by the acquirer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image forming system according to an embodiment;

FIG. 2 is a block diagram illustrating a functional configuration of the image forming system according to the present embodiment;

FIG. 3 illustrates an example of an intermediate transfer belt encoder signal;

FIG. 4 illustrates an example case where estimated image noise information is collated with image data to be printed and image noise appears on the image data;

FIG. 5 illustrates an example where the occurrence of image noise is avoided by adjusting the image reference position;

FIG. 6 illustrates an example case where an instantaneous fluctuation occurs owing to the entrance of the first sheet into the secondary transfer rollers and exposure noise appears on the second sheet;

FIG. 7 illustrates an example case where an instantaneous fluctuation occurs owing to the entrance of the sheet into the secondary transfer roller and transfer noise appears on the sheet;

FIG. 8 illustrates an example case where the timing of transferring an image to the next sheet is not adjusted according to the image layout on the sheet;

FIG. 9 illustrates an example case where the timing of transferring an image to the next sheet is adjusted according to the image layout on the sheet;

FIG. 10 illustrates an example of a profile in which sheet physical property information is associated with image noise information (image noise estimation result);

FIG. 11 is a flowchart illustrating an example of control by the image forming system in the present embodiment;

FIG. 12 illustrates an example in which estimated image noise information is collated with image data to be printed and image noise appears; and

FIG. 13 illustrates an example in which the imposition is corrected to avoid the occurrence of image noise.

### DETAILED DESCRIPTION

Hereinafter, one or more embodiments of the present invention will be described with reference to the drawings. However, the scope of the invention is not limited to the disclosed embodiments.

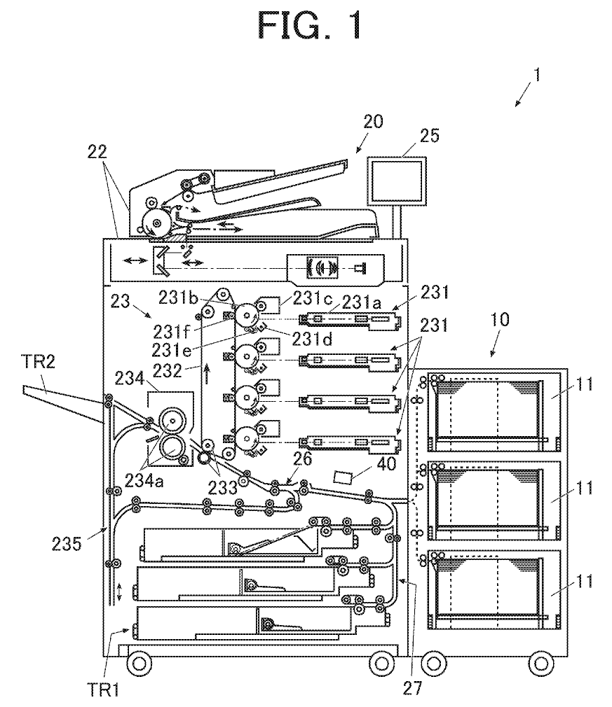

As illustrated in FIG. 1, an image forming system 1 according to the present embodiment includes a sheet feed device 10 and an image forming apparatus 20.

The sheet feed device 10 includes a plurality of sheet feed trays 11 and a sheet feed means (not illustrated), and feeds sheets stored in the sheet feed trays 11 to the image forming apparatus 20. The sheet feed means includes, for example, a sheet feed roller, a separation roller, a sheet feed/separation rubber, and a feed-out roller. Each sheet feed tray 11 stores sheets by the sheet type (e.g., paper type, basis weight, sheet size). The sheet feed device 10 conveys sheets one by one from the topmost sheet stored in each sheet feed tray 11 to the image forming apparatus 20.

The image forming apparatus 20 forms an image on a sheet, based on print data.

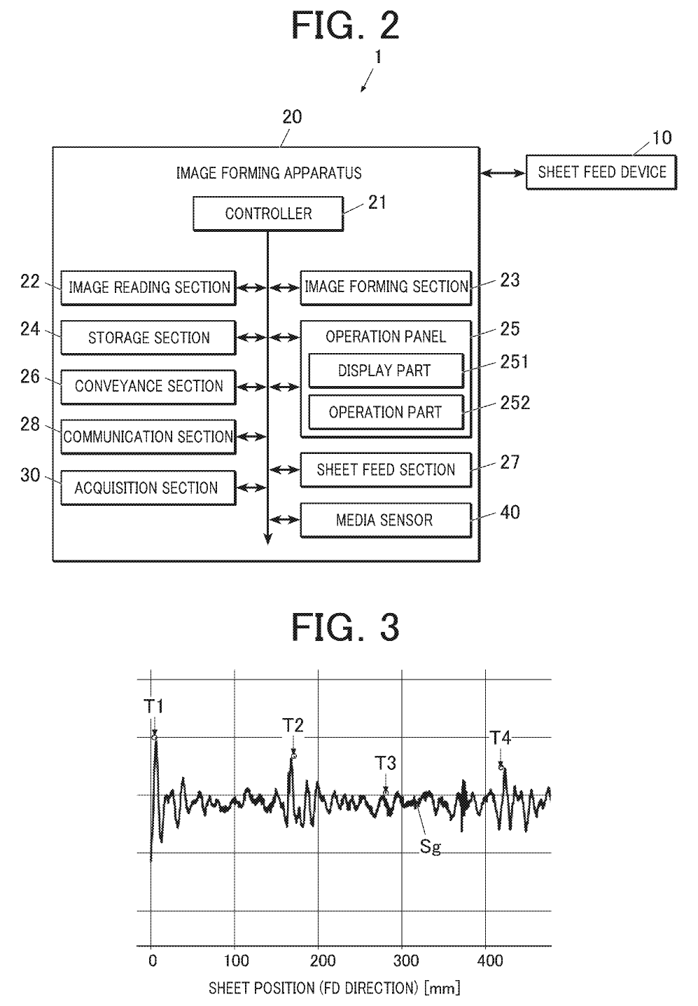

As illustrated in FIG. 1 and FIG. 2, the image forming apparatus 20 includes a controller 21 (hardware processor), an image reading section 22, an image forming section 23 (image former), a storage section 24, an operation panel 25, a conveyance section 26, a sheet feed section 27, and a communication section 28. The image forming apparatus 20 further includes an acquisition section 30 (acquirer) and a media sensor 40 (sensor).

The controller 21 includes a CPU, a RAM, and a ROM. In response to various signals, the CPU reads various programs stored in the ROM and loads them in the RAM. The various signals include an operation signal input from the operation part 252 and an instruction signal received by the communication section 28. The CPU then centrally controls the operation of the image forming apparatus 20 in cooperation with the various programs loaded in the RAM.

The image reading section 22 scans and exposes an image of a document placed on a document plate or an automatic document feeder (ADF) by an optical system of a scanning exposure device. The image reading section 22 reads the reflected light with a line image sensor to obtain an image signal. The image signal is subjected to processing, such as A/D conversion, shading correction, and compression and then input as image data to the controller 21.

The image forming section 23 forms an image on a sheet (flat cut sheet) by the electrophotographic method, based on print data. The print data is image data read by the image reading section 22 or image data received from an external device. The image forming section 23 forms an image on a sheet via image carriers (photoreceptor 231b and intermediate transfer belt 232). The image forming section 23 forms an image of four colors of C, M, Y, and K on the sheet, based on the pixel values of the four colors of each pixel of the image data.

The image forming section 23 includes four writing sections 231, an intermediate transfer belt 232, secondary transfer rollers 233, and a fixing section 234.

The four writing sections 231 are arranged in series (tandem) along the belt surface of the intermediate transfer belt 232 and form images of C, M, Y and K colors. The writing sections 231 have the same configuration except that they form images in different colors. Each writing section 231 includes an optical scanner 231a, a photoreceptor 231b, a developing section 231c, a charging section 231d, a cleaning section 231e, and a primary transfer roller 231f.

In image formation, each writing section 231 firstly charges the photoreceptor 231b with the charging section 231d. Next, based on the image data, the writing section 231 scans the surface of the photoreceptor 231b with the light flux emitted by the optical scanner 231a to form an electrostatic latent image. The writing section 231 then causes the developing section 231c to supply toner and develop the image. Thus, the monochrome toner image is formed on the photoreceptor 231b.

Next, each writing section 231 transfers, with the primary transfer roller 231f, the image formed on the photoreceptor 231b onto the intermediate transfer belt 232 such that the image is superposed onto each other (primary transfer). Thus, a color toner image consisting of four colors is formed on the intermediate transfer belt 232. Each writing section 231 then causes the cleaning section 231e to remove the toner remaining on the photoreceptor 231b.

In the image forming section 23, a sheet is fed from the sheet feed tray 11 or the sheet feed tray TR1 in accordance with the timing at which the image on the rotating intermediate transfer belt 232 reaches the position of the secondary transfer rollers 233. One of the paired secondary transfer rollers 233 is pressed against the intermediate transfer belt 232, and the other of the secondary transfer rollers 233 constitute rollers around which the intermediate transfer belt 232 is wound. By the pressure contact of the secondary transfer rollers 233, the image forming section 23 transfers the color toner image from the intermediate transfer belt 232 onto the sheet (secondary transfer). The image forming section 23 then conveys the sheet to the fixing section 234 for the fixing process. In the fixing process, the fixing roller 234a applies heat and pressure to the sheet so that the image is fixed on the sheet. When forming images on both sides of the sheet, the image forming section 23 conveys the sheet to a reverse path 235 to reverse the sheet and then feeds the sheet again to the position of the secondary transfer rollers 233.

The storage section 24 is a nonvolatile storage means constituted by an HDD, an SSD, or the like. The storage section 24 stores various programs and various kinds of setting data to be readable and writable by the controller 21.

The operation panel 25 includes a display part 251 that displays various kinds of information to a user and an operation part 252 that receives an operation input by the user.

The display part 251 consists of a color liquid crystal display, for example. The display part 251 displays operation screens (e.g., various setting screens, various buttons, operational statuses of the respective functions) in accordance with display control signals input by the controller 21.

The operation part 252 includes a touch screen provided on the screen of the display part 251 and various hard keys arranged around the screen of the display part 251. When a button displayed on the screen is pressed with a finger, a touch pen, or the like, the operation part 252 detects the coordinate of the pressed position by a voltage value. The operation part 252 then outputs, to the controller 21, a signal associated with the detected position. The touch screen is not limited to a pressure-sensitive type but may be an electrostatic type or an optical type, for example. When one of the hard keys is pressed, the operation part 252 outputs an operation signal associated with the pressed key to the controller 21.

The conveyance section 26 includes a plurality of roller pairs. The conveyance section 26 conveys the sheet supplied by the sheet feed section 27 to the image forming section 23 and ejects the sheet on which an image has been formed by the image forming section 23 to the sheet ejection tray TR2.

The sheet feed section 27 includes a plurality of sheet feed trays TR1, and supplies sheets from the sheet feed trays TR1 to the image forming section 23. Each sheet feed tray TR1 stores sheets of a predetermined paper type and size.

The communication section 28 is an interface that includes a communication IC and a connector and connects the image forming apparatus 20 to a network. Under the control of the controller 21, the communication section 28 transmits and receives various kinds of information to and from an external device connected to the network, according to a predetermined communication protocol. The communication section 28 can input and output various kinds of information via a USB.

The acquisition section 30 is hardware that monitors electrical signals inside the apparatus. Examples of the electrical signals inside the apparatus include a reference signal of an image or a sheet (a signal indicating the position of the leading end) and a drive signal for driving the image carrier. The acquisition section 30 acquires, for example, fluctuation information that indicates fluctuations in the drive signal for driving the image carrier. The drive signal for driving the image carrier is, for example, a photoreceptor encoder signal or an intermediate-transfer-belt encoder signal. The photoreceptor encoder signal is output by an encoder provided to each of the photoreceptors 231b for the respective colors of CMYK. The intermediate-transfer-belt encoder signal is output by an encoder provided to the intermediate transfer belt 232. FIG. 3 shows an example of the intermediate-transfer-belt encoder signal Sg. The example of FIG. 3 shows that an instantaneous fluctuation occurs at timings indicated by T1 to T4. The reference numeral T1 indicates a timing at which the sheet enters the secondary transfer rollers 233. The reference numeral T2 indicates a timing at which the sheet enters the fixing rollers 234a. The reference numeral T3 indicates a timing at which the sheet passes through the registration roller. The reference numeral T4 indicates a timing at which the sheet passes through the secondary transfer rollers 233. The acquisition section 30 monitors the intermediate-transfer-belt encoder signal to acquire information on an instantaneous fluctuation occurring in the intermediate transfer belt, for example.

The media sensor 40 is provided to the conveyance route that conveys the sheet to the image forming section 23. The media sensor 40 reads the sheet fed from the sheet feed tray 11 or the sheet feed tray TR1 and detects physical property information of the sheet. That is, the media sensor 40 functions as a sensor of the present disclosure. The physical property information is related to the physical properties of the sheet. For example, the physical property information is information on paper type, weight, basis weight, sheet thickness, stiffness, and surface properties (e.g., smoothness, moisture percentage). The physical property information detected by the media sensor 40 is output to the controller 21.

The controller 21 controls the image formation position by the image forming section 23, based on the fluctuation information acquired by the acquisition section 30. Specifically, first, the controller 21 estimates image noise information (position and size (rank value) of shock noise), based on the fluctuation information acquired by the acquisition section 30. The controller 21 then controls the image formation position, based on the estimated image noise information. The controller 21 collates the estimated image noise information with image data to be printed. When the image noise occurrence position overlaps the image data, the controller adjusts the image reference position so that an image is not formed at the image noise occurrence position. Accordingly, the exposure, the primary transfer, and the secondary transfer are not performed when the conveyance fluctuation (instantaneous fluctuation in the sheet conveyance system) occurs. Thus, the generation of image noise can be suppressed.

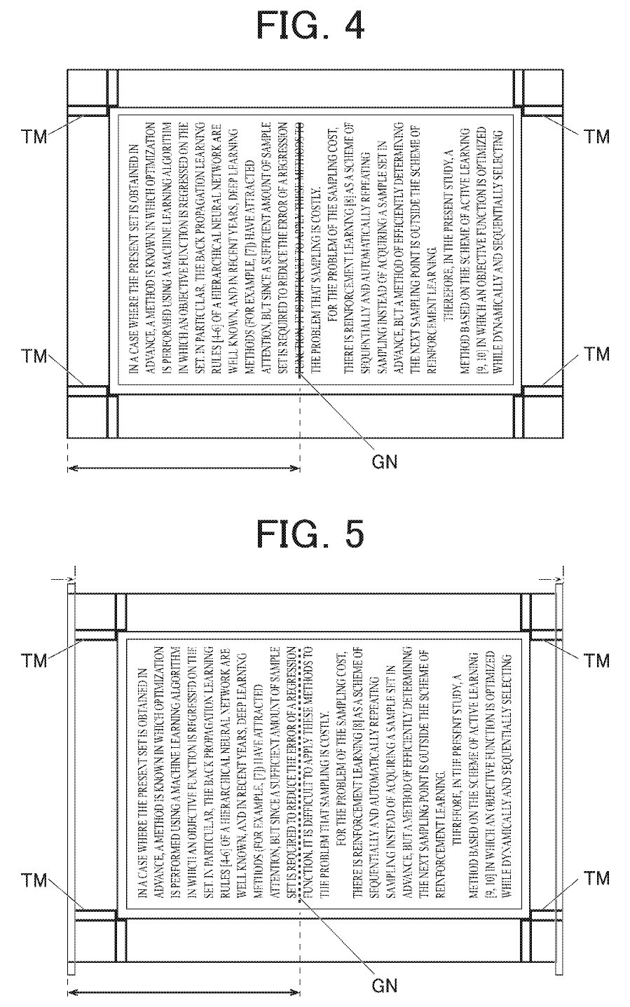

FIG. 4 illustrates an example case where the estimated image noise information is collated with the image data to be printed and image noise appears. FIG. 5 illustrates an example case where the occurrence of image noise is avoided by adjusting the image reference position.

In the example of FIG. 4, since the image data overlaps the image noise occurrence position (GN), the image noise GN appears.

To avoid this, the controller 21 adjusts the image reference position so as not to form the image at the image noise GN occurrence position. The image reference position is the position of a register mark as an image reference. In the example in FIG. 5, the position of the register mark TM is shifted so that the image data does not overlap the image noise GN occurrence position. Accordingly, the generation of the image noise GN is avoided. In FIG. 5, the image noise GN is depicted by a dotted line, which indicates that the image noise GN does not appear.

The controller 21 estimates the position of image noise, based on the fluctuation information that indicates fluctuations in the photoreceptor encoder signal acquired by the acquisition section 30. Based on the estimated position of image noise, the controller 21 controls the image formation position. In addition to the photoreceptor encoder signal, the controller 21 uses an image reference signal, a sheet reference signal, the size of the sheet in the conveyance direction, and/or the conveyance speed of the sheet to estimate the position of image noise.

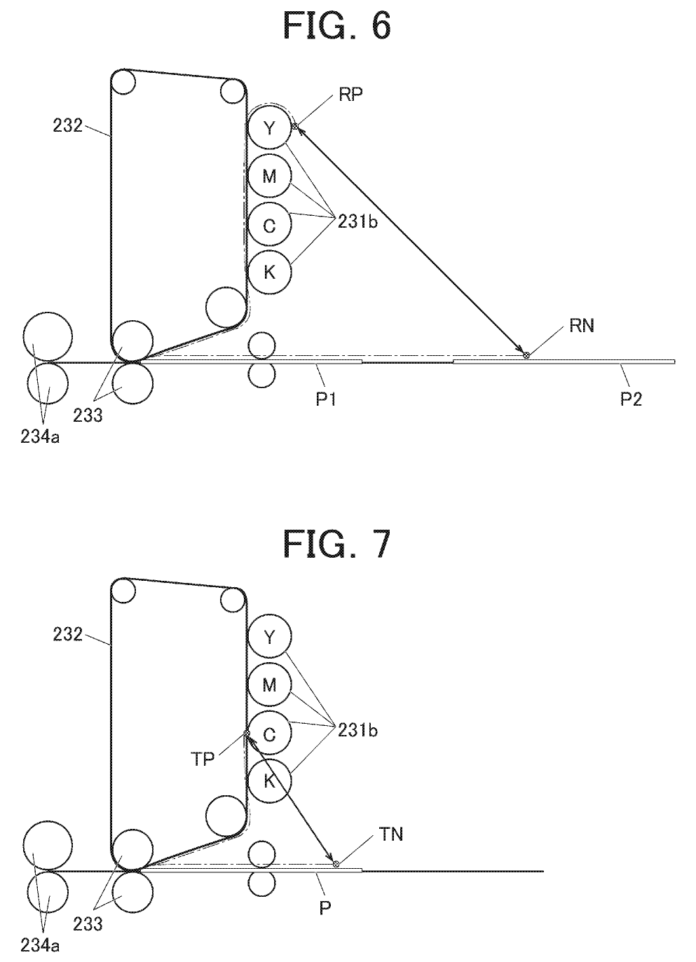

FIG. 6 illustrates an example case where an instantaneous fluctuation occurs owing to the entrance of the first sheet into the secondary transfer rollers 233 and exposure noise appears on the second sheet. As illustrated in FIG. 6, when the first sheet P1 enters the secondary transfer rollers 233, an instantaneous fluctuation occurs in the intermediate transfer belts 232. Further, via the intermediate transfer belt 232, an instantaneous fluctuation occurs on the photoreceptor 231b. The reference sign RP in the figure indicates the exposure position of the photoreceptor 231b. Based on the fluctuation information on the photoreceptor encoder signal, the controller 21 estimates image noise information (position and size of image noise). As a result of the estimation, the controller 21 finds that exposure noise RN will appear on the second sheet P2. Instead of the encoder signal, an FG signal may be used.

The controller 21 filters the photoreceptor encoder signal acquired by the acquisition section 30 with a band-pass filter to extract an image noise component (a component of a specific band). Next, the controller 21 integrates the regression coefficient with the extracted image noise component (peak value) to obtain the size (rank value) of the image noise.

Based on the fluctuation information of the intermediate-transfer-belt encoder signal acquired by the acquisition section 30, the controller 21 estimates the position of the image noise. Then, based on the estimated position of the image noise, the controller 21 controls the image formation position. In addition to the intermediate-transfer-belt encoder signal, the controller 21 uses the image reference signal, the sheet reference signal, the size of the sheet in the conveyance direction, and/or the conveyance speed of the sheet to estimate the position of the image noise.

FIG. 7 illustrates an example case where an instantaneous fluctuation occurs owing to the entrance of the sheet into the secondary transfer rollers 233 and transfer noise appears on the sheet. As shown in FIG. 7, when the sheet P enters the secondary transfer rollers 233, an instantaneous fluctuation occurs in the intermediate transfer belt 232. The instantaneous fluctuation causes noise on the image that is being transferred from the photoreceptor 231b to the intermediate transfer belt 232. Further, noise occurs on the image that is being transferred from the intermediate transfer belt 232 to the sheet P. The symbol TP in the figures indicates the transfer position of the photoreceptor 231b. Based on the fluctuation information on the intermediate-transfer-belt encoder signal, the controller 21 estimates image noise information (position and size of image noise). As a result of the estimation, the controller 21 finds that transfer noise TN will appear on the sheet P on which the image is being transferred. Instead of the encoder signal, an FG signal may be used.

The controller 21 filters the intermediate-transfer-belt encoder signal acquired by the acquisition section 30 with a band-pass filter to extract an image noise component (a component of a specific band). Next, the controller 21 integrates the regression coefficient with the extracted image noise component (peak value) to obtain the size (rank value) of the image noise.

Based on the fluctuation information acquired by the acquisition section 30, the controller 21 controls the image transfer position on to the second and subsequent sheets by the image forming section 2. Specifically, in a case where the image noise position estimated from the insertion of the first sheet overlaps the position of the image data to be printed, the controller 21 shifts (corrects) the position of the register mark for the second and subsequent sheets by about several millimeters. Thus, even when an instantaneous fluctuation occurs by the entry or the exit of the sheet, occurrence of image noise on the second and subsequent sheets can be avoided.

Based on the fluctuation information acquired by the acquisition section 30, the controller 21 controls the image transfer timing by the image forming section 23 on the second and subsequent sheets. Specifically, in a case where the image noise position estimated from the insertion of the first sheet overlaps the position of the image data to be printed, the controller 21 adjusts the conveyance speed of the second and subsequent sheets to adjust (correct) the timing at which the second and subsequent sheets enter the secondary transfer rollers 233 by about several milliseconds. Instead of the sheet conveyance speed, the timing of starting the registration motor may be adjusted. Thus, even when an instantaneous fluctuation occurs by the entry or the exit of the sheet, occurrence of image noise on the second and subsequent sheets can be avoided.

Based on the fluctuation information on the previous sheet acquired by the acquisition section 30, the controller 21 controls the image transfer timing by the image forming section 23 onto the next sheet. Specifically, in a case where the image noise position estimated from the insertion of the previous sheet overlaps the position of the image data to be printed, the controller 21 adjusts the conveyance speed of the next sheet to adjust (correct) the timing at which the next sheet enters the secondary transfer rollers 233 by about several milliseconds. Instead of the sheet conveyance speed, the timing of starting the registration motor may be adjusted. Thus, even when an instantaneous fluctuation occurs by the entry or the exit of the sheet, occurrence of image noise on the next sheet can be avoided.

Based on the fluctuation information on the previous sheet acquired by the acquisition section 30, the controller 21 controls the image transfer timing for the next sheet by the image forming section 23 according to the layout of the image on the sheet. Specifically, the controller 21 refers to the layout of the image on the sheet. When the image noise position estimated by the insertion of the previous sheet overlaps the position of the image data to be printed, the controller 21 adjusts the conveyance speed of the next sheet to adjust (correct) the timing at which the next sheet enters the secondary transfer rollers 233 by about several milliseconds.

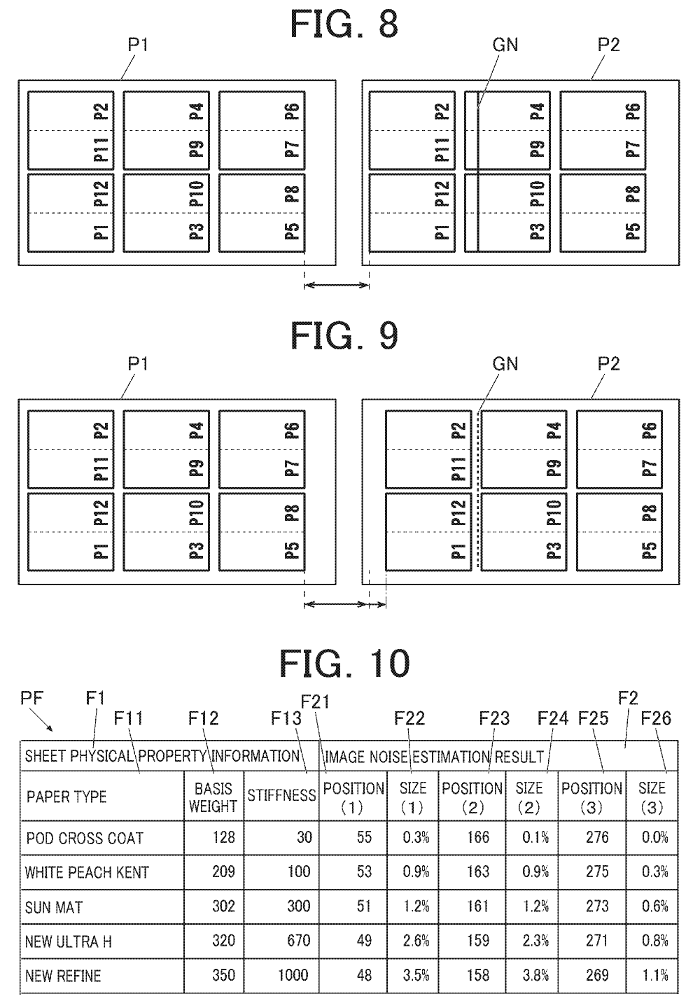

FIG. 8 illustrates an example case where the image transfer timing to the next sheet is not adjusted according to the image layout on the sheet. FIG. 9 illustrates an example case where the image transfer timing to the next sheet is adjusted according to the image layout on the sheet.

In the example of FIG. 8, the position of the image noise GN estimated from the insertion of the previous sheet (first sheet P1) overlaps the image position on the next sheet (second sheet P2), and the image noise GN appears on the next sheet.

In the example of FIG. 9, the conveyance speed of the next sheet is adjusted and the image transfer timing to the next sheet is adjusted so that the position of the image noise GN estimated from the insertion of the previous sheet does not overlap the position of the image data on the next sheet. Thus, in the example of FIG. 9, the image noise GN does not appear on the next sheet. In FIG. 9, the image noise GN is depicted by a dotted line, which indicates that the image noise GN does not appear.

The controller 21 controls the image transfer timing for the next sheet by the image forming section 23, based on the fluctuation information of the previous sheet acquired by the acquisition section 30, and based on the imposition. Specifically, the controller 21 refers to the imposition. In a case where the image noise position estimated from the insertion of the previous sheet overlaps the position of the image data to be printed, the controller 21 adjusts the conveyance speed of the next sheet to adjust (correct) the timing at which the next sheet enters the secondary transfer rollers 233 by about several milliseconds.

The controller 21 creates a profile of the sheet physical property information detected by the media sensor 40 and the image noise information estimated based on the fluctuation information acquired by the acquisition section 30. The created profile is stored in the storage section 24.

FIG. 10 shows an example of the profile PF in which the sheet physical property information is associated with the image noise information (image noise estimation result).

The profile PF includes the fields of sheet physical property information F1 and image noise estimation result F2. The sheet physical property information F1 includes fields of a paper type F11, a basis weight F12, and a stiffness F13. The image noise estimation result F2 has fields for the image noise position (1) F21, the size thereof (1) F22, the image noise position (2) F23, the size thereof (2) F24, the image noise position (3) F25, and the size thereof (3) F26. For example, in the sheet physical property information F1 of the first record, the paper type F11 is POD cross coat, the basis weight F12 is 128 (kg), and the stiffness F13 is 30. In the first record, the image noise estimation result F2 indicates that the image noise position (1) F21 is 55 and that the size thereof (1) F22 is 0.3%. Further, the image noise position (2) F23 is 166, and the size thereof (2) F24 is 0.1%. Further, the image noise position (3) F25 is 276, and the size thereof (3) F26 is 0.0%. As described above, the profile PF indicates a correspondence between the sheet physical property information and the image noise information. With reference to the profile PF, the image noise information (position and size of image noise) that may occur on the sheet can be estimated, based on the sheet physical property information.

The controller 21 controls the image formation position based on the profile PF. For example, the controller 21 collates image noise that is visualized based on the profile PF read from the storage section 24 with the image data. The controller 21 adjusts the image reference position (the position of the register mark TM) so that the image data does not overlap the image noise position. Thus, the controller 21 can control the image formation position without inserting the sheet. Such a configuration is especially effective in suppressing image noise that is caused by mutual fluctuations between the sheet and the intermediate transfer belt 232 when the sheet enters or exits from the secondary transfer rollers 233.

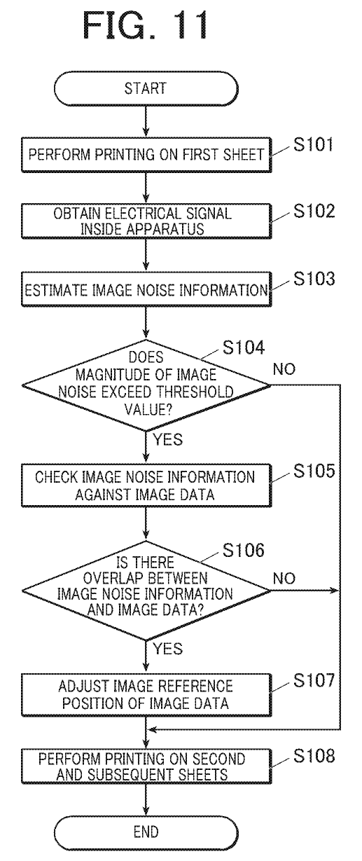

Next, the control by the image forming system 1 according to the present embodiment will be described with reference to the flowchart of FIG. 11. The control in FIG. 11 starts when the power of the image forming apparatus 20 is turned on.

First, the controller 21 causes the image forming section 23 to perform printing on a first sheet, based on image data to be printed (step S101).

Next, the controller 21 causes the acquisition section 30 to acquire an electrical signal inside the apparatus (step S102). The electrical signal inside the apparatus includes fluctuation information indicating fluctuations in a drive signal that drives the image carrier(s).

Next, based on the fluctuation information acquired in step S102, the controller 21 estimates image noise information (position and size of image noise) (step S103).

Next, the controller 21 determines whether the size of the image noise estimated in step S103 exceeds a threshold value (step S104).

When determining that the size of the image noise exceeds the threshold value (step S104: YES), the controller 21 proceeds to the next step S105.

When determining that the size of the image noise is equal to or less than the threshold value (step S104: NO), the controller 21 determines that the influence of the image noise can be ignored, and proceeds to step S108.

In step S105, the controller collates the image noise information estimated in step S103 with the image data to be printed.

Next, the controller 21 determines whether the image noise information estimated in step S103 overlaps the image data to be printed (step S106).

When determining that the image noise information overlaps the image data to be printed (step S106: YES), the controller 21 proceeds to the next step S107.

When determining that the image noise information does not overlap the image data to be printed (step S106: NO), the controller 21 proceeds to step S108.

In step S107, the controller 21 adjusts the image reference position of the image data to be printed so that the image data does not overlap the image noise position.

In step S108, the controller 21 causes the image forming section 23 to perform printing on the second and subsequent sheets, based on the image data to be printed.

As described above, the image forming apparatus 20 according to the present embodiment includes the image forming section 23, the acquisition section 30, and the controller 21. The image forming section 23 forms an image on a sheet via image carriers (photoreceptor 231b and intermediate transfer belt 232). The acquisition section 30 acquires fluctuation information on a drive signal that drives the image carriers. The controller 21 controls the image formation position by the image forming section 23, based on the fluctuation information acquired by the acquisition section 30.

According to the image forming apparatus 20 of the present embodiment, it is possible to avoid the image formation at the timing when an instantaneous fluctuation in the sheet conveyance system occurs. Thus, the occurrence of image noise can be avoided. Thus, it is possible to sufficiently secure image quality while suppressing time and cost.

Further, the controller 21 estimates image noise information based on the fluctuation information acquired by the acquisition section 30, and controls the image formation position based on the estimated image noise information. The controller 21 estimates the position of image noise, based on the fluctuation information on the photoreceptor encoder signal and the intermediate-transfer-belt encoder signal acquired by the acquisition section 30. Based on the estimated position of image noise, the controller 21 controls the image formation position.

Thus, the occurrence of image noise can be avoided. Thus, it is possible to sufficiently secure image quality while suppressing time and cost.

Furthermore, the controller 21 controls the image transfer position by the image forming section 23 on the second and subsequent sheets, based on the fluctuation information acquired by the acquisition section 30.

Therefore, it is possible to avoid the occurrence of image noise in real time while executing a job. Therefore, it is possible to sufficiently secure image quality while suppressing a decrease in productivity.

Furthermore, the controller 21 controls the image transfer timing by the image forming section 23 onto the second and subsequent sheets, based on the fluctuation information acquired by the acquisition section 30.

Therefore, it is possible to avoid the occurrence of image noise in real time while executing a job. Therefore, it is possible to sufficiently secure image quality while suppressing a decrease in productivity.

Furthermore, the controller 21 controls the timing at which the image forming section 23 transfers an image onto the next sheet, based on the fluctuation information on the previous sheet acquired by the acquisition section 30. The controller 21 controls the timing at which the image forming section 23 transfers an image onto the next sheet, based on the fluctuation information on the previous sheet acquired by the acquisition section 30 and based on the layout or imposition of the image on the sheet.

Therefore, it is possible to avoid the occurrence of image noise in real time while executing a job. Therefore, it is possible to sufficiently secure image quality while suppressing a decrease in productivity.

Furthermore, the image forming apparatus 20 includes a sensor (media sensor 40) that detects physical property information of the sheet. The controller 21 creates a profile of the physical property information of the sheet, which is detected by the sensor, and the image noise information, which is estimated based on the fluctuation information acquired by the acquisition section 30. The controller 21 controls the image formation position, based on the profile.

Therefore, the image noise information (position and size) on the image noise that will occur on the sheet can be estimated from the physical property information of the sheet. Thus, the controller 21 can control the image formation position without inserting the sheet. Such a configuration is especially effective in suppressing image noise that is caused by mutual fluctuations between the sheet and the intermediate transfer belt 232 when the sheet enters or exits from the secondary transfer rollers 233.

Although the embodiment of the present disclosure has been described in detail, the above embodiment is not intended to limit the present disclosure and can be variously modified without departing from the scope of the present disclosure.

For example, although the image reference position is adjusted (see FIG. 4 and FIG. 5) in controlling the image formation position in the above embodiment, the present disclosure is not limited thereto. For example, the orientation of the image to be printed may be changed to correct (edit) the imposition.

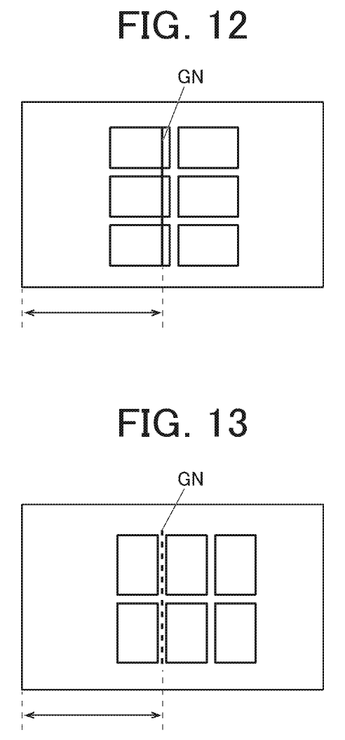

FIG. 12 shows an example in which the estimated image noise information is collated with the image data to be printed and image noise appears. FIG. 13 shows an example in which imposition is corrected to avoid generation of image noise.

In the example of FIG. 12, since the image data overlaps the image noise GN occurrence position, the image noise GN appears.

The controller 21 corrects the imposition such that an image is not formed at the image noise GN occurrence position. In the example of FIG. 13, the image to be printed is rotated to adjust the imposition so that the image data does not overlap the image noise GN occurrence position. Accordingly, the occurrence of the image noise GN is avoided. In FIG. 13, the image noise GN is depicted by a dotted line, which indicates that the image noise GN does not appear.

In the above embodiment, one media sensor 40 is provided to the conveyance path that conveys the sheet to the image forming section 23, for example. However, the present disclosure is not limited to this. For another example, one media sensor 40 may be provided to each sheet feed tray 11 and each sheet feed tray TR1.

Further, the detailed configuration and operation of each device constituting the image forming system can be appropriately modified without departing from the scope of the present disclosure.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms an image on a sheet via an image carrier;
an acquirer that acquires fluctuation information indicating a fluctuation in a drive signal that drives the image carrier; and
a hardware processor that controls an image formation position at which the image is formed by the image former, based on the fluctuation information acquired by the acquirer.

2. The image forming apparatus according to claim 1, wherein:
based on the fluctuation information acquired by the acquirer, the hardware processor estimates image noise information on image noise, and
based on the estimated image noise information, the hardware processor controls the image formation position.

3. The image forming apparatus according to claim 2, wherein:
based on the fluctuation information on a photoreceptor encoder signal acquired by the acquirer, the hardware processor estimates a position of the image noise, and
based on the estimated position of the image noise, the hardware processor controls the image formation position.

4. The image forming apparatus according to claim 2, wherein:
based on the fluctuation information on an intermediate-transfer-belt encoder signal acquired by the acquirer, the hardware processor estimates a position of the image noise, and
based on the estimated position of the image noise, the hardware processor controls the image formation position.

5. The image forming apparatus according to claim 1, wherein
based on the fluctuation information acquired by the acquirer, the hardware processor controls an image transfer position on second and subsequent sheets onto which the image is transferred by the image former.

6. The image forming apparatus according to claim 1, wherein
based on the fluctuation information acquired by the acquirer, the hardware processor controls a timing at which the image former transfers the image onto second and subsequent sheets.

7. The image forming apparatus according to claim 1, wherein
based on the fluctuation information on a previous sheet acquired by the acquirer, the hardware processor controls a timing at which the image former transfers the image onto a next sheet.

8. The image forming apparatus according to claim 7, wherein
based on the fluctuation information on the previous sheet acquired by the acquirer and according to a layout of the image on the sheet, the hardware processor controls the timing at which the image former transfers the image onto the next sheet.

9. The image forming apparatus according to claim 7, wherein
based on the fluctuation information on the previous sheet acquired by the acquirer and according to imposition, the hardware processor controls the timing at which the image former transfers the image onto the next sheet.

10. The image forming apparatus according to claim 2, further comprising a sensor that detects physical property information of the sheet, wherein
the hardware processor creates a profile of the physical property information of the sheet detected by the sensor and the image noise information estimated based on the fluctuation information acquired by the acquirer.

11. The image forming apparatus according to claim 10, wherein the hardware processor controls the image formation position, based on the profile.

12. An image formation position control method for an image forming apparatus that includes: an image former that forms an image on a sheet via an image carrier; and an acquirer that acquires fluctuation information indicating a fluctuation in a drive signal that drives the image carrier, the method comprising controlling an image formation position at which the image is formed by the image former, based on the fluctuation information acquired by the acquirer.

13. A non-transitory computer-readable storage medium storing a program for a computer of an image forming apparatus that includes: an image former that forms an image on a sheet via an image carrier; and an acquirer that acquires fluctuation information indicating a fluctuation in a drive signal that drives the image carrier, the program causing the computer to control an image formation position at which the image is formed by the image former, based on the fluctuation information acquired by the acquirer.
